(19) United States
(12) Patent Application Publication
(10) Pub. No.: US 2004/0211687 A1
(43) Pub. Date: Oct. 28, 2004

(54) Compact golf bag

(76) Inventor: Roman Visos Rodriguez, A Coruna (ES)

Correspondence Address: KRAMER & AMADO, P.C., 2001 JEFFERSON DAVIS HWY, SUITE 1101, ARLINGTON, VA, 22202, US

(21) Appl. No.: 10/808,331

(22) Filed: Mar. 25, 2004

(30) Foreign Application Priority Data
Apr. 24, 2003 (ES) ES 200302155 U

(51) Int. Cl. B62B 7/00; A45F 4/00

(52) U.S. Cl. 206/315.3; 190/8; 280/DIG. 6

(57) ABSTRACT

The compact golf bag (1) incorporates a casing (2) of rigid material and houses on its interior, between its larger and smaller bases, an eccentric cylindrical chamber (6) which, on one side remains near the inside wall of the casing (2) and to which it is attached in at least two attachment points, whereas on the opposite side it remains separated from said wall and with which it defines an intermediate compartment. The casing (2) has an access aperture (7) coinciding with the compartment, provided with a collapsible cover (8) fixed to the casing (2) by means of joint members (9), said cover (8) being provided on its inside wall with pockets (10) which, in the closed position of the aperture (7), occupy the intermediate compartment. On the other hand, the locomotion means (4) and the drive means (5) attached to the casing (2) are collapsible, and are provided with a folding system (11). In addition, the bag comprises a collapsible body (16) with a seat (17) on its upper end.

This application claims priority to Spanish Patent Application No. ES 2003021585, filed Apr. 24, 2003.

### OBJECT OF THE INVENTION

The present invention relates to a compact golf bag which is used to keep and carry golf clubs and other objects before, during, and after practicing this sport.

### BACKGROUND OF THE INVENTION

The practice of golf has increased considerably in the last years. Direct contact with the nature and features of this sport gives rise to this sport having more followers each day. The challenge of personal betterment and, as a result, innovation in the equipment and attire used for its practice are present is this sport.

In the field of sport clothing, clubs, balls, support tees, etc., technical advances are introduced by means of the application of new materials and designs that help to improve golfing. However, with regards to other equipment characteristic of this sport such as trolleys and bags for carrying the clubs, hardly any changes have been introduced.

Typically, for the development of the game, a conventional golf player has to acquire devices for carrying the golf clubs such as a bag, a trolley to carry the bag, and a safe. In fact, if he travels frequently by plane or train, he will need a safety bag, which will not ensure the protection of the game equipment against impacts during transfers. If the total cost of all these elements needed for golfing was calculated, a considerable sum of money would be obtained.

Another aspect to take into account is the one relative to traveling by plane, due to the problem of checking in each one of those protective elements.

Therefore, the need arises for a compact system that overcomes the aforementioned disadvantages, such as the compact golf bag developed by the present invention.

### DISCLOSURE OF THE INVENTION

The present invention relates to a compact golf bag which performs the function of protecting and carrying the golf clubs, replacing the bags, trolleys and cases commonly used in the practice of this sport with a single product.

The compact bag is manufactured based on a rigid material, such as polypropylene, thus dispensing with the case mentioned above, providing at the same time an effective protection against impacts during transfers from one location to another.

Thus, the player is provided with greater comfort for travel and achieves greater financial saving in that three elements are substituted by a single product.

The compact golf bag of the invention is of the type comprising a hollow casing having a substantially frustoconical configuration, the larger base of which is covered by a collapsible cap hinged to the upper edge of one side of the casing, the top and bottom halves of which have attached thereto locomotion means and a drive means, and is characterized in that the casing is made of a rigid material and houses in its interior, between its larger and smaller bases, an eccentric cylindrical chamber which, on one side remains near the inside wall of the casing and to which it is attached in at least two attachment points, whereas on the opposite side it remains separated from said wall and with which it defines an intermediate compartment; said casing having an access aperture coinciding with the compartment, provided with a collapsible cover fixed to the casing by means of joint members, said cover being provided on its inside wall with pockets which, in the closed position of the aperture, occupy the intermediate compartment, and in that the locomotion means and the drive means attached to the casing are collapsible, said locomotion means being provided with a folding system.

### BRIEF DESCRIPTION OF THE DRAWINGS

In order to complete the disclosure and to aid in better understanding the features of the invention, the present specification is accompanied by figures in which with an illustrative and non-limiting character, the following has been represented:

FIG. 1 shows a side view of the bag, in the open position.

FIG. 2 shows a side view of the bag of the invention in the closed position.

FIG. 3 shows a perspective view of the folding system for the wheels according to the invention.

FIG. 4 shows a side view of the bag with a collapsible seat.

FIG. 5 shows a view of the collapsible seat attachable to the bag of the invention.

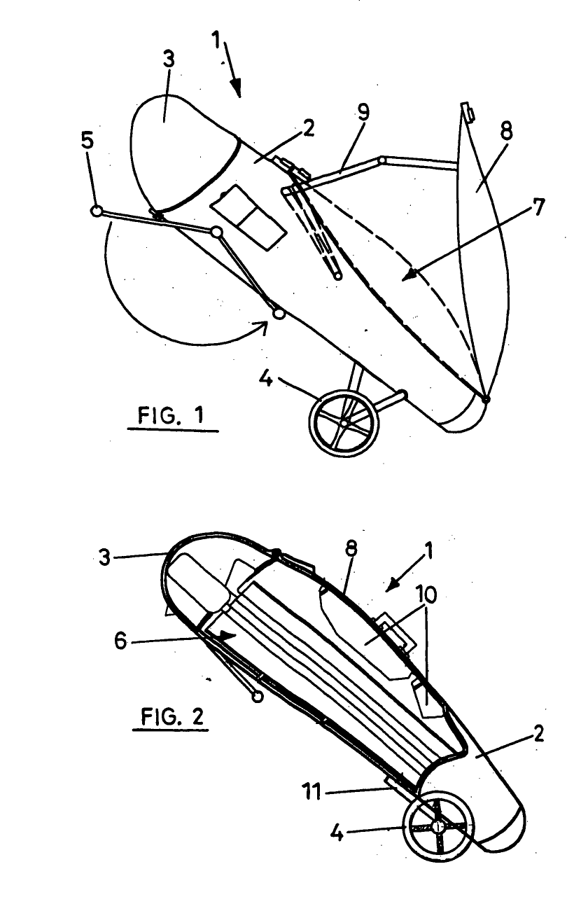

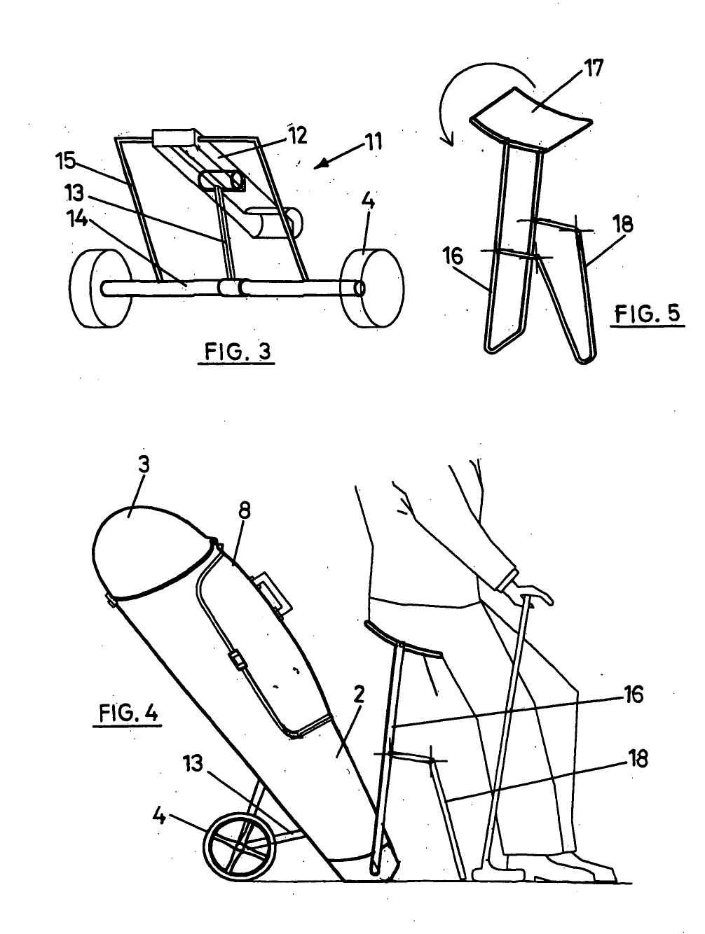

### EMBODIMENT OF THE INVENTION

In order to better explain the invention, an embodiment is disclosed below with the aid of the figures that, nevertheless, does not exhaust the possibilities and features of the invention.

The bag (1) comprises a hollow casing (2), based on a rigid material such as rigid polypropylene, that ensures the protection of the game equipment when transported by plane or train. The casing (2) has a substantially frustoconical configuration, although it can be carried out in a rectangular configuration. Said configuration facilitates access to the club heads. Its larger base is covered by a collapsible cap (3) being hingedly attached to the upper edge of one side of the casing (2). The design of the cap (3) allows for the club heads to freely turn without impairing the closing of the bag, and provides an effective shelter thereof.

On the opposite side, the casing (2) further comprises locomotion means (4) attached to the bottom half by means of a folding system (11), and a drive means (5) attached to the top half. Such means (4) and (5) are deployable at the time of transport, facilitating thereby the reduction of the dimensions of the bag when carried by car or plane.

The casing (2) houses in its interior, between its larger and smaller bases, an eccentric cylindrical chamber (6) which, on one side remains near the inside wall of the casing (2) and to which it is attached in at least two attachment points, whereas on the opposite side it remains separated from said wall and with which it defines an intermediate compartment. The cylindrical chamber (6) is subdivided into independent longitudinal compartments, sized to house golf clubs. These compartments are manufactured in the shape of aluminum tubes of 25 mm in diameter, which are lined with cloth so as to avoid scratching them.

The casing (2), coinciding with the intermediate compartment defined by the chamber (6) and the inside wall thereof, has a wide access aperture (7) which is provided with a collapsible cover (8) fixed to the casing (2) by means of joint members (9). For its mechanical opening, the cover (8) is attached to the casing by means of hinges or using a hinge and a jointed arm. The arm is mounted between the cover (8) and the inside of the casing (2).

The cover (8) is provided on its inside wall with pockets (10) which occupy the intermediate compartment when the aperture (7) is closed. The pockets (10) are sized so as to store shoes, balls, tees, etc. The airtight closure of the cover and the cap is ensured by using rubber or silicon seals.

The locomotion means (4) and the drive means (5), respectively attached to the bottom and top halves of the casing (2), are collapsible. The locomotion means (4) are provided with a folding system (11).

The folding system (11) comprises a rail (12) longitudinally anchored to the bottom half of the casing (2), which is sized to allow the movement and housing of a connecting rod (13) that, on one of its ends, is fixed to a shaft (14) carrying the locomotion members (4). The rail (12) has, on one of its ends, a bridge (15) attached to said shaft (14) by means of two arms. The upper end of the connecting rod (13) moves along the rail (12) and, when extended, is housed inside the end of the rail where the bridge (15) does not cross over, i.e. in the end closest to the smaller base of the casing (2). When the folding system (11) is folded, the upper end of the connecting rod (13) moves along the inside of the rail, being housed in the end farthest from the bottom base of the casing (2).

By means of this folding system (11), transport and handling during transport by plane, train, etc., are facilitated. Furthermore, the locomotion members maintain the dimensions of the conventional bag-carrying trolleys, thus preventing damage to the golf course.

In an additional embodiment of the invention, the bag of the present invention is provided with a seat (17) collapsible on the top surface of the casing (2), i.e. the one where the access cover (8) is provided on. The seat (17) consists of a rectangular base, although it can also be circular, for supporting the person. Said seat is coupled to the bottom base of the casing (2) by means of a U-shaped body (16), both parallel branches of which run on both sides of the casing and remain attached by their ends to both sides of the seat, allowing turning thereof, whereas its horizontal branch passes through the interior of the bottom base of the casing (2), acting as a rotation shaft, in order to allow for the parallel branches of the body (16) to be collapsed on the access cover (8), which are provided with a V-shaped, jointed support means (18) for leaning on the ground.

1. A compact golf bag (1) of the type comprising a hollow casing (2) having a substantially frustoconical configuration, the larger base of which is covered by a collapsible cap (3) hinged to the upper edge of one side of the casing (2), the top and bottom halves of which have attached thereto locomotion means (4) and a drive means (5), characterized in that the casing (2) is made of a rigid material and houses in its interior, between its larger and smaller bases, an eccentric cylindrical chamber (6) which, on one side remains near the inside wall of the casing (2) and to which it is attached in at least two attachment points, whereas on the opposite side it remains separated from said wall and with which it defines an intermediate compartment; said casing (2) having an access aperture (7) coinciding with the compartment, provided with a collapsible cover (8) fixed to the casing (2) by means of joint members (9), said cover (8) being provided on its inside wall with pockets (10) which, in the closed position of the aperture (7), occupy the intermediate compartment, and in that the locomotion means (4) and the drive means (5) attached to the casing (2) are collapsible, said locomotion means (4) being provided with a folding system (11).

2. A bag according to claim 1, characterized in that the chamber (6) is provided with individual longitudinal compartments, sized to house golf clubs.

3. A bag according to claim 1, characterized in that the cap (3) and the cover (8) are provided with airtight seals.

4. A bag according to claim 1, characterized in that the joint members (9) comprise at least a hinge and a collapsible jointed arm mounted between the cover (8) and an inside point of the casing (2).

5. A bag according to claim 1, characterized in that the folding system (11) comprises a rail (12) longitudinally anchored to the bottom half of the casing (2) and sized to allow the movement and housing in its ends of a connecting rod (13) that, on its lower end, is fixed to a shaft (14) carrying the locomotion members (4), said rail being provided with a bridge (15) attached to said shaft by means of two arms.

6. A bag according to claim 1, characterized in that it comprises a U-shaped body (16), both parallel branches of which run on both sides of the casing (2), remaining attached by their ends to a collapsible seat (17) and having a jointed support means (18), and the horizontal branch of which passes through the interior of the bottom base of the casing (2), acting as a rotation shaft.
